(19) United States
(12) Patent Application Publication
(10) Pub. No.: US 2016/0063096 A1
(43) Pub. Date: Mar. 3, 2016

(54) IMAGE RELEVANCE TO SEARCH QUERIES BASED ON UNSTRUCTURED DATA ANALYTICS

(71) Applicant: International Business Machines Corporation, Armonk, NY (US)

(72) Inventors: James E. Bostick, Cedar Park, TX (US); John M. Ganci, JR., Cary, NC (US); Sarbajit K. Rakshit, Kolkata (IN); Craig M. Trim, Sylmar, CA (US)

(21) Appl. No.: 14/470,056

(22) Filed: Aug. 27, 2014

(51) Int. Cl. G06F 17/30; G06Q 30/02

(52) U.S. Cl. CPC G06F 17/30687; G06F 17/30244; G06F 17/30864; G06F 17/3089; G06Q 30/0277

(57) ABSTRACT

A computer processor identifies a search result of a plurality of search results that includes one or more images and unstructured data corresponding to metadata of the one or more images and the text content in proximity of the one or more images. The computer processor performs a semantic analysis of the unstructured data of the search result, and determines a relevance of the one or more images to the unstructured data of the search result, based, at least in part, on the semantic analysis of the unstructured data and the one or more images of the search result. The computer processor determines a count of the one or more images determined to be relevant to the search result, and ranks the search result of the plurality of search results, based on the count of the one or more images determined to be relevant to the search result.

### BACKGROUND OF THE INVENTION

The present invention relates generally to the field of search relevance of web content, and more particularly to inferring context using image based analytics.

There is a saying that a picture is worth a thousand words. The expression captures the efficiency in which information can be bundled into an image; information that otherwise requires a great deal of textual expression to describe, orient, and relate. Queries performed on Internet search engines depend on keywords or key-phrases to match content on web pages. Search results often require a user to sort through results to determine the content that is most relevant and provides reference that may include images supporting the query purpose.

### SUMMARY

According to one embodiment of the present invention, a method for determining a search result having one or more images that are relevant to text content of the search result, is provided. A computer processor identifies a search result of a plurality of search results that includes one or more images and unstructured data corresponding to metadata of the one or more images, and unstructured data corresponding to text content in proximity of the one or more images. The computer processor performs a semantic analysis of the unstructured data of the search result. The computer processor determines a relevance of the one or more images to the unstructured data of the search result, based, at least in part, on the semantic analysis of the unstructured data and the one or more images of the search result. The computer processor determines a count of the one or more images determined to be relevant to the search result, and the computer processor ranks the search result of the plurality of search results, based on the count of the one or more images determined to be relevant to the search result.

### BRIEF DESCRIPTION OF THE DRAWINGS

FIG. 1 is a functional block diagram illustrating a distributed computer processing environment, in accordance with one embodiment of the present invention.

FIG. 2 illustrates an example of search results of a web-based search.

FIG. 3A illustrates an example of an image included within the web page of a search result, in accordance with an embodiment of the present invention.

FIG. 3B illustrates an example of search results of a web-based search using an image relevance program, in accordance with an embodiment of the present invention.

FIG. 4 illustrates the operational steps of an image relevance program, operating on a web search server within the distributed computer processing environment of FIG. 1, in accordance with an embodiment of the present invention.

FIG. 5 depicts a block diagram of components of a web search server capable of operating the image relevance program, in accordance with an embodiment of the present invention.

### DETAILED DESCRIPTION

Embodiments of the present invention recognize that web-based search results often include images that in combination with the text content of a search result web page, may facilitate the understanding and comprehension of the search topic by a user. Often, search results web pages related to the search query, but may not indicate the inclusion and relevance of images associated with the search results web pages. Embodiments of the present invention use unstructured data analytic techniques of images and the association of unstructured data, such as the text content of a web page, to assess the image relevance to the user query. Some embodiments arrange the display order to prioritize search results based on the number of relevant images associated with a web page of the search results, such that search results having fewer relevant images associated with a web page are displayed following results having more relevant images associated with a web page. Some embodiments of the present invention exclude web page images associated with advertisements, and still other embodiments arrange the relevant images within each search result web page in an order of relevance to the search query.

The relevance of images to the content and context of a search result web page is determined by applying semantic analysis to the metadata of images and comparing the result to the semantic analysis of the unstructured text content of the web page and search query terms. The combination of an image and text, in the context of the web page, provides greater detail and information with regard to a search query. Search result web pages that include text content and are lacking or offer limited relevant images, may require significantly more text to provide precise description or adequate detail to achieve the level of information that relevant images are able to convey.

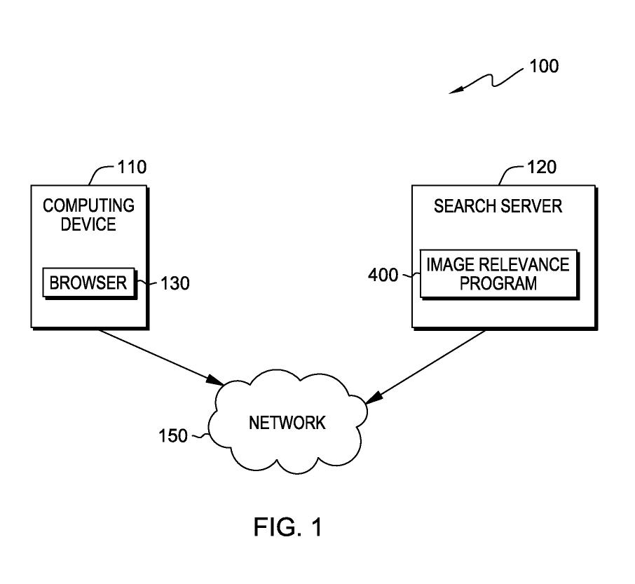

The present invention will now be described in detail with reference to the Figures. FIG. 1 is a functional block diagram illustrating a distributed computer processing environment, generally designated 100, in accordance with an embodiment of the present invention. FIG. 1 provides only an illustration of one implementation and does not imply any limitations with regard to the environments in which different embodiments may be implemented. Many modifications to the depicted environment may be made by those skilled in the art without departing from the scope of the invention as recited by the claims.

FIG. 1 includes computing device 110 and search server 120, interconnected via network 150. Network 150 can be, for example, a local area network (LAN), a telecommunications network, a wide area network (WAN), such as the Internet, a virtual local area network (VLAN), or any combination that can include wired, wireless, or fiber optic connections. In general, network 150 can be any combination of connections and protocols that will support communications between computing device 110 and search server 120, in accordance with embodiments of the present invention.

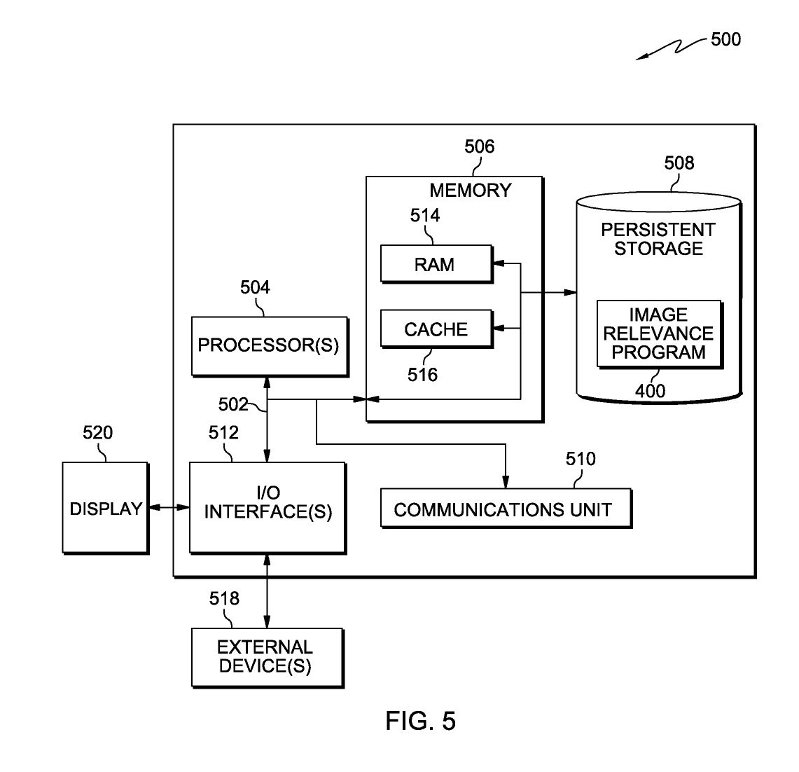

Computing device 110 is a client-based computing device shown to include browser 130. Computing device 110 may be a management server, a web server, a web search engine, a mobile computing device, or any other electronic device or computing system capable of receiving and sending data. In other embodiments, computing device 110 may represent a virtual computing device of a computing system utilizing multiple computers as a server system, such as in a cloud computing environment. In another embodiment, computing device 110 may be a laptop computer, a tablet computer, a netbook computer, a personal computer (PC), a desktop computer, a personal digital assistant (PDA), a smart phone, or any programmable electronic device capable of communicating with search server 120, via network 150. In another embodiment, computing device 110 represents a computing system utilizing clustered computers and components (e.g., database server computer, application server computers, etc.) that act as a single pool of seamless resources when accessed within distributed processing environment 100. Computing device 110 may include internal and external hardware components, as depicted and described with reference to FIG. 5.

Browser 130 is an application accessible to computing device 110 that enables a user of computing device 110 to connect to a network-based search server and submit a search query. The network-based search server, for example, search server 120, may be a server of a local area network (LAN), a wide area network (WAN), or the Internet. Browser 130 also enables computing device 110 to receive search query results from a web search server, such as search server 120.

Search server 120 is a computing device that includes image relevance program 400, and is capable of operating program 400 within distributed computer processing environment 100. Search server 120 may be a management server, a web server, a web search engine, a mobile computing device, or any other electronic device or computing system capable of receiving and sending data. In other embodiments, web search server 120 may represent a virtual computing device of a computing system utilizing multiple computers as a server system, such as in a cloud computing environment. In another embodiment, search server 120 may be a laptop computer, a tablet computer, a netbook computer, a personal computer (PC), a desktop computer, a personal digital assistant (PDA), a smart phone, or any programmable electronic device capable of performing search query operations of web content, based on search queries communicated from computing device 110, via network 150. In another embodiment, search server 120 represents a computing system utilizing clustered computers and components (e.g., database server computer, application server computers, etc.) that act as a single pool of seamless resources when accessed within distributed processing environment 100. Search server 120 may include internal and external hardware components, as depicted and described with reference to FIG. 5.

Image relevance program 400 is accessible and operated by search server 120. In embodiments of the present invention, image relevance program 400 works in conjunction with search applications to determine the search results that include images. Image relevance program 400 determines the number of images included in each result of a search query, which may include a plurality of web pages associated with the search term, for example. In some cases, web pages may include images associated with advertisements. Search query result web pages often include an advertising block within the right hand section of the web page, and advertising images are often located within the block. In one embodiment of the present invention, image relevance program 400 determines the images to be associated with advertisement by parsing the hypertext markup language (HTML) pages and loading the parsed page sections into a tree-like structure. By referring to the HTML tags of the web page, the layout of the web page can be determined. Images located in particular sections of the web page, such as the right hand side, are distinguishable from images within the body of the web page content, enabling image relevance program 400 to exclude advertising images.

Image relevance program 400 performs semantic analysis on the metadata associated with the images of the search results. Semantic analysis focuses on the relation of words, phrases, and symbols, to their meaning as used in human language understanding. Image metadata may include acronyms, abbreviations, and phrases. Collapsing phrases, expanding abbreviations and acronyms, or reversal of word order may be performed in semantic analysis to find similar content. Other semantic techniques may include recognition of word combinations commonly used together. If the metadata includes one or more of a known combination of words (or common expression), semantic analysis may be able to infer the missing word(s). Semantic analysis, performed as a part of natural language programming, enables image relevance program 400 to determine the meaning and relationships of metadata associated with the image, and determine the relevance of the image to the text content of the web page in the proximity of the image.

Images of a web page may include metadata containing information related to the image. Image relevance program 400 uses semantic analysis of the image metadata to determine the relevance of the image to text content of the web page. The image metadata may include, but are not limited to: a file name, file size, author or photographer identity, physical size of the image, date of origin of the image, last modified date, location information, caption, description, keywords, and copyright information. Additionally, the metadata may include particular details associated with the device used to produce the image, including make, model, resolution, date and time image was taken, exposure time, shutter speed, F-number, aperture value, width and height in pixels, and flash conditions used. In some embodiments of the present invention, the relevancy of a search result page image to the corresponding text content of the page is expressed by image relevancy program 400 as a probability of similarity. The metadata also enables image relevance program 400 to identify an image and determine possible duplicates.

If image relevance program 400 determines there to be duplicate images associated with search results, image relevance program 400 may select and aggregate the metadata associated with the duplicate images, forming a stronger metadata basis of the image, but image relevance program 400 only considers one of the duplicate images (and assigns the aggregate metadata to the selected image) and excludes the other duplicates. Excluded images are not considered when determining the number of relevant images associated with a search result.

In an embodiment of the present invention, image relevance program 400 determines the number of relevant images associated with each of the search results, and ranks the search results web pages based on the number of relevant images associated with each of the search result web pages. For example, a search result determined to have five images with relevance to the text content of the web page and the content of the search query, is ranked higher than a search result web page having three images relevant to the text content and search query. Search result web pages without images rank below result web pages that include relevant images.

In an embodiment of the present invention, image relevance program 400 shows “thumbnail” sized images as part of the search result display for search results that include relevant images. Including the images as part of the display indicates to a user that the search result includes a combination of web page text content and relevant images. The thumbnail sized images are displayed in a sequence based on the level of relevancy determined by image relevance program 400 for each image of the search result web page.

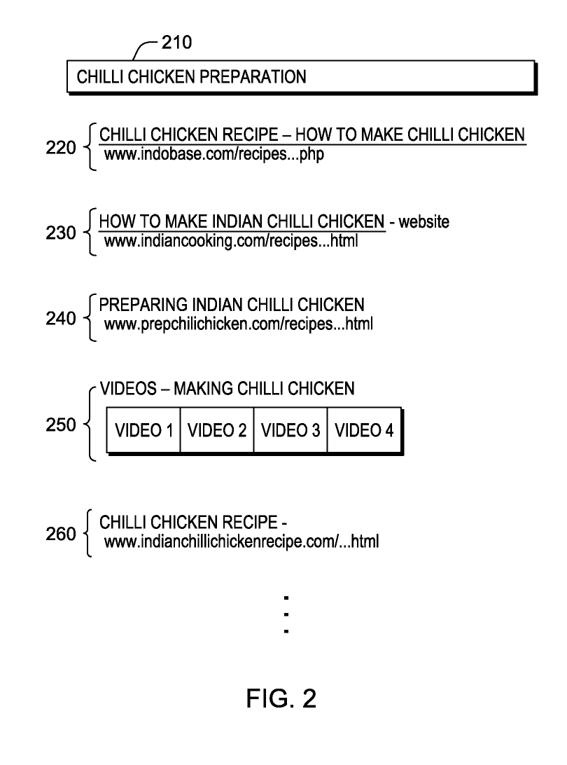

FIG. 2 illustrates an example of search results of a web-based search query.

FIG. 2 includes search term 210, and a partial listing of search results, which includes result 220, result 230, result 240, result 250 and result 260. Results 220, 230, 240, 250 and 260, are links to web pages that have been determined to be relevant to search term 210, by search server 120. Result 220, 230, 240, 250, and 260 also include a title indicating information associated with search term 210 that can be found on the respective result web page. In addition, result 220, 230, 240, 250, and 260 may include a universal resource locator (URL) address, and may include a brief partial extract of text content from the web page (not shown). The content associated with a search result is often in an unstructured data format, containing mostly text. The content of search results from a web-based search query, as well as the metadata associated with images included in the search results, are predominantly text-based and are also considered to be unstructured data. References to search results, herein, include the content of the search result and search query terms, images associated with the search result, and the metadata associated with the images. References to unstructured data associated with an image of a search result include the text-based metadata of the image, and references to unstructured data associated with a search result are inclusive of the content of the search result pages, images included within the search result, and metadata associated with the images.

Search term 210 includes an exemplary search term for the preparation of a food dish referred to as “chilli chicken”. The search results include links to web pages that have titles relevant to search term 210. Result 220 and result 260 indicate their respective web page content is associated with a recipe for chilli chicken. Result 220 indicates a further reference to instructions of “how to make chilli chicken”.

Similarly, result 230 and result 240 indicate that the web page is associated with chilli chicken, but also includes information associated with an Indian type of chilli chicken. Both results 230 and 240 indicate in their respective titles that the information associated with the respective web pages includes instructional or preparatory information. Result 250 clearly indicates that the search result links to multiple videos of making chilli chicken; however, there is no additional information indicating if a written recipe is available, or if the video is associated with a particular type of chilli chicken.

Results 220, 230, 240, 250, and 260 are displayed without any specific reference as to the availability of images within the result web pages, if any, the number of images that may be available, nor the relevance of the images to the search query, search term 210. Often, the combination of images and text content both relevant to context of a search query, offers additional information and improves understanding compared to search results having only text content, or a mixture of relevant and irrelevant images. To determine whether results 220, 230, 240, 250, and 260 include relevant images requires selecting the result and examining the associated web page content. Acting upon results 220, 230, 240, 250, and 260 consumes significant time, and settling for web page content that lacks relevant images, that may be available but are not easily identifiable, may result in difficulty or delay in comprehension of the search query subject.

Result 250 includes links to multiple videos that are associated with making chilli chicken. The videos may be instructive; however, the video may lack a text-based listing of ingredients and text-based direction to follow. Text-based content is often printable and may be useful for a user to obtain the necessary ingredients before beginning preparation. Additionally, having printable content allows reference to the recipe without online access. Although a video may be informative and helpful, the combination of text content of a web page and relevant images will often provide more useful information and facilitation of understanding of search result content.

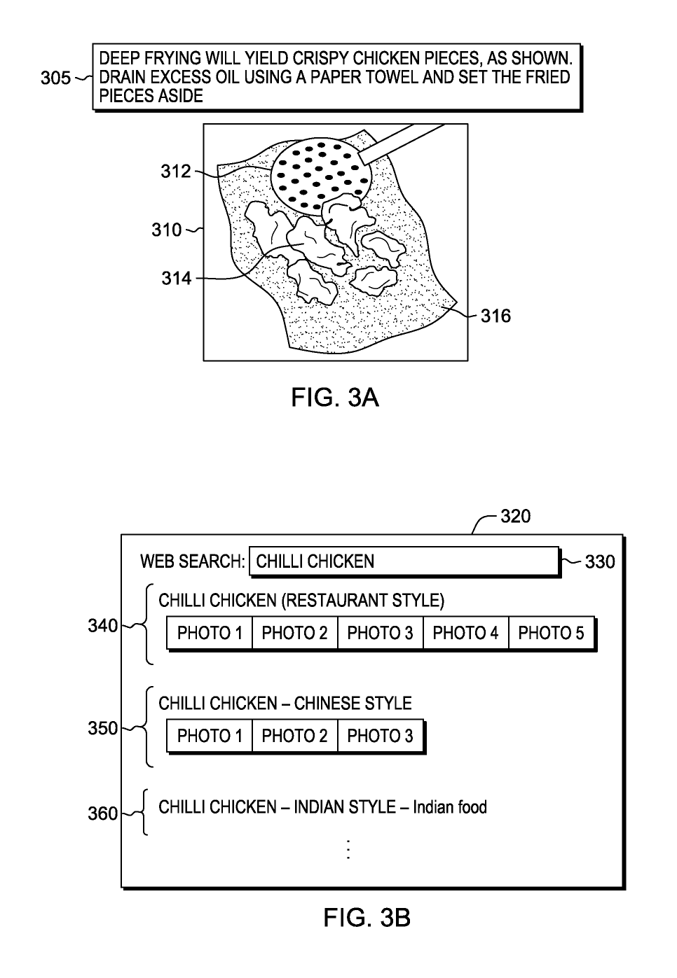

FIG. 3A is a functional block diagram depicting an example image included within the web page of a search result, in accordance with an embodiment of the present invention. FIG. 3A includes web page text 305 and image 310. Web page text 305 is instructive text of a web page result associated with a search query for making chilli chicken. Web page text 305 includes text that describes the result of completing a step in making chilli chicken, and instructs a user to drain excess cooking oil by using a paper towel and setting the fried pieces aside. Image 310 depicts straining spoon 312 used to remove the cooked chicken pieces from the cooking oil, chicken pieces 314, and paper towel 316. In one embodiment of the present invention, a search result that includes image 310 in combination with web page text 305, illustrates to a user a utensil to use to remove the chicken pieces from the cooking oil, how to place the chicken pieces, and to use the paper towel as a surface on which the chicken pieces are placed to drain the excess oil. Image 310 serves as an example of one or more procedural steps and includes additional information to be inferred by the user by observing the image, beyond the information provided by web page text 305 alone.

FIG. 3B is a functional block diagram depicting example results 320 of a web-based search using image relevance program 400, in accordance with an embodiment of the present invention. Example results 320 includes search field 330, first result 340, second result 350, and third result 360. Search field 330 depicts “chilli chicken” as the subject of a web-based search. For example, the search term “chilli chicken” is entered into search field 330 on browser 130, running on computing device 110. Search server 120 performs a search using the “chilli chicken” search term and returns example results 320.

First result 340 includes a search result title and indicators of relevant images associated with first result 340. In one embodiment of the present invention, first result 340 includes a thumbnail sized image for each of five relevant images found on the search result web page of first result 340. In another embodiment, a symbol or other representation may be displayed with first result 340 (not shown), indicating that first result 340 includes relevant images, with the number of symbols or representations indicating the number of relevant images (five) found on first result 340 web page. Similarly, second result 350 is displayed with a search result title and indicators of relevant images associated with second result 350. The indicators of relevant images may be thumbnail images, symbols, or other representation; however, second result 350 is displayed after first result 340 because second result 350 has three relevant images associated with the search result, whereas first result 340 includes five relevant images. In some embodiments of the present invention, image relevance program 400 displays search results having a higher number of relevant images before search results having fewer number of relevant images. Third result 360 does not include relevant images on the search result web page, and is therefore displayed after both first result 340 and second result 350.

Example results 320 depicts an embodiment of the present invention in which the image relevance program 400 has determined the search results that include relevant images, and orders the display such that the results having the higher number of relevant images are displayed before results with fewer relevant images.

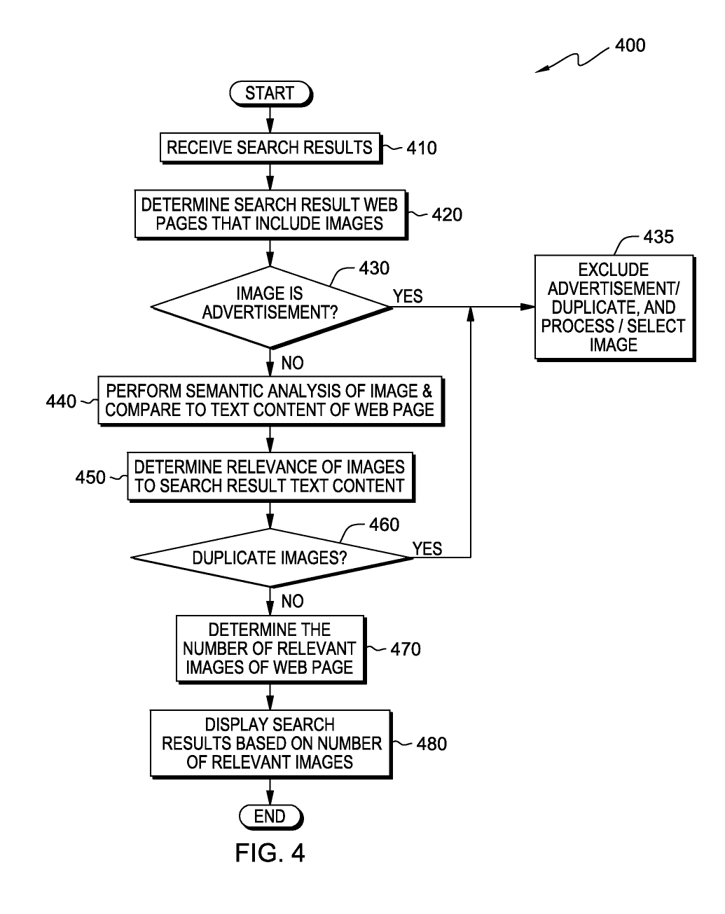

FIG. 4 illustrates the operational steps of image relevance program 400, operating on search server 120 within distributed computer processing environment 100 of FIG. 1, in accordance with an embodiment of the present invention. Image relevance program 400 receives search query results (step 410). Working in conjunction with a search application, image relevance program 400 receives the search results from a search query performed by the search application operating on a search server, for example, search server 120. The displayed information of the search results include the terms used in the search query, along with the text content of the title and description of each search result. The search query terms and the text content of each search result are used to determine the relevancy of images that have been determined to be included within web pages of the search results. For example, image relevance program 400, operating on search sever 120 (FIG. 1), receives the search results and search query information, from a search sent from browser 130 operating on computing device 110.

Image relevance program 400 examines the search results and determines the search result web pages that include images (step 420). Images that occur within an HTML web page are identified by the file extension of the image, such as gif, jpg, tif, png, etc., and may also be identified by other HTML tags used in the web page. Image relevance program 400 examines the search results web pages using the file extensions and web page tags to determine which of the search result web pages include images.

It should be mentioned that in some embodiments of the present invention, the number of search results on which image relevance program 400 performs image identification, semantic analysis, and relevancy determination, may be limited by applying a set-up parameter to image relevance program 400.

Having determined the search result web pages that include images, image relevance program 400 determines whether an image is an advertisement (decision step 430). If an image of a search result web page is an advertisement (step 430, “YES” branch), image relevance program 400 excludes the image (step 435). Images that are located in an advertising block of a web page are not relevant to the text content and context of the web page and do not improve the understanding of the web page content. Advertising related images are frequently located in the right hand side of a web page, often in a block of table cells used for advertising. Image relevancy program 400 may use structural tags of the web page HTML code to determine images associated with an advertising block located at the right hand side of a web page. Determining the image to be associated with advertising, image relevance program 400 excludes the identified image from consideration in the display of search results.

If the image is not an advertising image, (step 430, “NO” branch), image relevance program 400 performs semantic analysis of the image metadata, and compares the semantic analysis to the text content of the web page (step 440). The metadata of images may contain information about the properties and content of the image. Image relevance program 400 determines meaning with respect to natural language by performing semantic analysis on the metadata of images of search result web pages. The image metadata may include, but are not limited to: a file name, file size, author or photographer identity, physical size of the image, date of origin of the image, last modified date, location information, caption, description, keywords, and copyright information. Additionally, the metadata may include particular details associated with the device used to produce the image, including make, model, resolution, date and time image was taken, exposure time, shutter speed, F-number, aperture value, width and height in pixels, and flash conditions used. The results of the semantic analysis of image metadata are compared to the analysis results of the text content of the web page to determine the level of relevance In some embodiments the analysis of the text content of the web pate includes semantic analysis of the web page text content. Image relevance program 400 may also compare the semantic analysis information to the search query terms.

For example, semantic analysis is performed on the metadata of image 310 (FIG. 3A). The semantic analysis determines a topic of “draining chicken pieces on paper towel”, associated with a caption of the image. Additionally, the image title includes “deep fried pieces for chilli chicken”. Image relevance program 400 compares the information from the semantic analysis of the metadata to text content of the web page adjacent to the image, which includes: “Deep frying will yield crispy chicken pieces, as shown. Drain excess oil using a paper towel and set the fried pieces aside”. Image relevance program 400 compares the semantic analysis information, “draining chicken pieces on paper towel”, and “deep fried pieces for chilli chicken”, to the web page text content in the proximity of the image, “Deep frying will yield crispy chicken pieces, as shown. Drain excess oil using a paper towel and set the fried pieces aside”, and to the search query terms, “chilli chicken”.

In one embodiment of the present invention, image relevance program 400 may search for a second instance of an image, outside of the search result, to obtain additional metadata for a first instance of an image that contains little or no metadata. Having located a second instance of the image that includes additional metadata, image relevance program 400 aggregates and applies the metadata of the second instance to the first instance of the image, to be used for semantic analysis. If other instances of the image are not found or not available, image relevance program 400 may not be able to perform a semantic analysis or determine relevance of the image to the text content of the search result web page.

Having compared the text content of the web page to the analyzed image metadata, image relevance program 400 determines the relevance of the images to the text content of the web page and the terms used for the search query (step 450). Keyword matching and other similarity determination techniques may be used to determine the level of relevance. In one embodiment of the present invention, the level or relevance of the image to the query search terms, and the text content of the web page, in a proximate location of the image, is expressed in a probability of similarity or probability of a similar match. In other embodiments, the level of relevancy may be a scoring approach based on common or near-common terms, keywords, or phrases. In yet other embodiments, the text content of the entire web page may be used to determine the relevance of the image to the text content of the search result.

For example, the semantic analysis of the metadata of image 310 determines the keywords and key phrases “chilli chicken”, “deep fried”, “pieces”, “draining pieces on paper towel”. The semantic analysis is a very close match to text content of the web page associated with the image, “Deep frying will yield crispy chicken pieces, as shown. Drain excess oil using a paper towel and set the fried pieces aside”. Image relevance program 400 determines the relevance level to be high based on the comparison of the words and phrases, for example, a relevance probability of 0.91678.

Image relevance program 400 determines if there are duplicates of the image (decision step 460), and confirming that an image is a duplicate (step 460, “YES” branch), image relevance program 400 excludes the image, returns, and selects the next image (step 435). Duplicate images may be determined by comparison of the properties and descriptive metadata associated with the images. For example, properties associated with the device that created the image may include the date, time, location, shutter speed, aperture setting, and device type information. The properties information of two or more images may indicate that they are the same image. Similarly, the metadata associated with the image, such as image size, file size, date of origin, file name, title, caption, and description information may indicate there are duplicates of an image. Image relevance program 400 excludes the duplicate images.

If one or more duplicate images are determined, it may be the case that one instance of the image has additional data, or metadata, than other instances of the image. Image relevance program 400 may aggregate the metadata of the duplicate images to generate an enhanced set of metadata, and apply the aggregate metadata to one of the images. The remaining duplicate images are excluded and not counted in determining the number of relevant images associated with a search result web page. Having excluded duplicate images, image relevance program 400 returns and continues processing of the one image instance, with enhanced metadata, which was not excluded (step 460, “NO” branch).

Subsequent to excluding advertisement-related images, excluding duplicate images, and determining the relevance of images, image relevance program 400 determines the number of relevant images of the search result web page (step 470). The combination of web page text content and images relevant to the text content, may significantly improve the understanding of the content of a search result. Embodiments of the present invention consider the number of relevant images of a search result web page to be an indication of additional information contributing to the understanding of the search result content.

For example, a search query for “chilli chicken” returns a plurality of search results, and image relevance program 400 determines the search results that include images, such as result 350 (FIG. 3B). Image relevance program 400 determines if images of result 350 are advertisements and excludes the advertisement images. Image relevance program 400 determines the relevance of the images of a search result web page to the text content of the web page. The determination of relevance may be based, at least in part, on the text content in proximity of an image, which, for example, may include a paragraph above and below an image, or may be based, at least in part, on the entire text content of the web page. It is pointed out that a threshold of relevance may be established in a setup property of image relevance program 400, and if the relevance of an image does not pass the threshold level, then the relevance is considered to be low and the image may be excluded. Image relevance program 400 determines if there are duplicate images, and if found, then they are excluded. Having established the relevant images of the search result web page, image relevance program 400 determines the number of relevant images.

Image relevance program 400 displays the search results based on the number of relevant images included in each result web page (step 480). Search results having a higher count of relevant images rank higher, whereas search results having a lower count of relevant images are ranked lower. In some embodiments of the present invention, search results are displayed in an order determined by the ranking of each search result, placing higher ranking search results before search results having a fewer number of relevant images. Search results without images are displayed following the search results having one or more relevant images. Some embodiments display search results consistent with the acknowledgement that search results having a combination of text content and relevant images provide enhancement of information and facilitate understanding of the search result content.

For example, result 340 includes five images that are relevant to the text content of the web page, and is displayed before result 350, which includes three images that are relevant to the text content of result 350's web page. Result 360 has no relevant images included in the search result web page, and is therefore displayed following search results that include relevant images.

FIG. 5 depicts a block diagram of components of search server system 500, capable of operating image relevance program 400, in accordance with an embodiment of the present invention. Components of search server 500 may also be representative of components of computing device 110. It should be appreciated that FIG. 5 provides only an illustration of one implementation and does not imply any limitations with regard to the environments in which different embodiments may be implemented. Many modifications to the depicted environment may be made.

Search server system 500 includes communications fabric 502, which provides communications between computer processor(s) 504, memory 506, persistent storage 508, communications unit 510, and input/output (I/O) interface(s) 512. Communications fabric 502 can be implemented with any architecture designed for passing data and/or control information between processors (such as microprocessors, communications and network processors, etc.), system memory, peripheral devices, and any other hardware components within a system. For example, communications fabric 502 can be implemented with one or more buses.

Memory 506 and persistent storage 508 are computer-readable storage media. In this embodiment, memory 506 includes random access memory (RAM) 514 and cache memory 516. In general, memory 506 can include any suitable volatile or non-volatile computer-readable storage media.

Image relevance program 400, and browser 130 are stored in persistent storage 508 for execution by one or more of the respective computer processors 504 via one or more memories of memory 506. In this embodiment, persistent storage 508 includes a magnetic hard disk drive. Alternatively, or in addition to a magnetic hard disk drive, persistent storage 508 can include a solid state hard drive, a semiconductor storage device, read-only memory (ROM), erasable programmable read-only memory (EPROM), flash memory, or any other computer-readable storage media that is capable of storing program instructions or digital information.

The media used by persistent storage 508 may also be removable. For example, a removable hard drive may be used for persistent storage 508. Other examples include optical and magnetic disks, thumb drives, and smart cards that are inserted into a drive for transfer onto another computer-readable storage medium that is also part of persistent storage 408.

Communications unit 510, in these examples, provides for communications with other data processing systems or devices, including resources of distributed computer processing environment 100. In these examples, communications unit 510 includes one or more network interface cards. Communications unit 410 may provide communications through the use of either or both physical and wireless communications links. Image relevance program 400 and browser 130 may be downloaded to persistent storage 508 through communications unit 510.

I/O interface(s) 512 allows for input and output of data with other devices that may be connected to client device 110 and search server 120. For example, I/O interface 512 may provide a connection to external devices 518 such as a keyboard, keypad, a touch screen, and/or some other suitable input device. External devices 518 can also include portable computer-readable storage media such as, for example, thumb drives, portable optical or magnetic disks, and memory cards. Software and data used to practice embodiments of the present invention, e.g., image relevance program 400 and browser 130 can be stored on such portable computer-readable storage media and can be loaded onto persistent storage 508 via I/O interface(s) 512. I/O interface(s) 512 also connect to a display 520.

Display 520 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A method for determining a search result, the method comprising:
identifying, by a computer processor, a search result of a plurality of search results that includes one or more images and unstructured data corresponding to metadata of the one or more images, and unstructured data corresponding to text content in proximity of the one or more images;
performing, by the computer processor, a semantic analysis of the unstructured data of the search result;
determining, by the computer processor, a relevance of the one or more images to the unstructured data of the search result, based, at least in part, on the semantic analysis of the unstructured data and the one or more images of the search result;
determining, by the computer processor, a count of the one or more images determined to be relevant to the search result; and
ranking, by the computer processor, the search result of the plurality of search results, based on the count of the one or more images determined to be relevant to the search result.

2. The method of claim 1, wherein the search result comprising a greater count of images that are relevant to the unstructured data of the search result, is prioritized ahead of another search result comprising a lesser count of images that are relevant to the unstructured data of the search result, as displayed in a listing of the plurality of search results.

3. The method of claim 1, further comprising:
determining, by the computer processor, a first image of the one or more images to be an advertising image included in the search result; and
excluding, by the computer processor, the first image from the count of the one or more images which are relevant to the search result.

4. The method of claim 1, wherein the one or more images included within the search result of the plurality of search results are displayed in a ranking order of an image of the one or more images, most relevant to the unstructured data of the search result to another image of the one or more images, least relevant to the unstructured data of the search result, wherein a level of relevance is based on a probability of similarity of the semantic analysis of the unstructured data of each of the one or more images to the unstructured data of the text content of the search result.

5. The method of claim 1, further comprising:
determining, by the computer processor, whether the one or more images of the search result forms a sequence, based on the unstructured data of the search result; and if so, initiating to display, by the computer processor, the one or more images according to the determined sequence.

6. The method of claim 1, wherein a duplicate image of the one or more images associated with the search result is excluded from determining the count of the one or more images relevant to the search result.

7. The method of claim 1, further comprising:
combining the unstructured data associated with duplicate images of the one or more images of the search result, into an enhanced set of unstructured data associated with one of the duplicate images.

8. The method of claim 1, wherein the relevance of the one or more images to the search result is determined based on comparing the semantic analysis of the unstructured data associated with each of the one or more images with the semantic analysis of the unstructured data associated with text content of the search result in proximity to the one or more images.

9. A computer program product for determining a search result having one or more images that are relevant to text content of the search result, the computer program product comprising:
a computer readable storage medium having program instructions embodied therewith, wherein the program instructions are executable by a computer processor to cause the computer processor to perform a method comprising:
identifying, by a computer processor, a search result of a plurality of search results that includes one or more images and unstructured data corresponding to metadata of the one or more images, and unstructured data corresponding to text content in proximity of the one or more images;
performing, by the computer processor, a semantic analysis of the unstructured data of the search result;
determining, by the computer processor, a relevance of the one or more images to the unstructured data of the search result, based, at least in part, on the semantic analysis of the unstructured data and the one or more images of the search result;
determining, by the computer processor, a count of the one or more images determined to be relevant to the search result; and
ranking, by the computer processor, the search result of the plurality of search results, based on the count of the one or more images determined to be relevant to the search result.

10. The computer program product of claim 9, wherein the search result comprising a greater count of images that are relevant to the unstructured data of the search result, is prioritized ahead of another search result comprising a lesser count of images that are relevant to the unstructured data of the search result, as displayed in a listing of the plurality of search results.

11. The computer program product of claim 9, further comprising:
determining, by the computer processor, a first image of the one or more images to be an advertising image included in the search result; and
excluding, by the computer processor, the first image from the count of the one or more images which are relevant to the search result.

12. The computer program product of claim 9, wherein the one or more images included within the search result of the plurality of search results are displayed in a ranking order of an image of the one or more images, most relevant to the unstructured data of the search result to another image of the one or more images, least relevant to the unstructured data of the search result, wherein a level of relevance is based on a probability of similarity of the semantic analysis of the unstructured data of each of the one or more images to the unstructured data of the text content of the search result.

13. The computer program product of claim 9, further comprising:
determining, by the computer processor, whether the one or more images of the search result forms a sequence, based on the unstructured data of the search result; and if so,
initiating to display, by the computer processor, the one or more images according to the determined sequence.

14. The computer program product of claim 9, wherein a duplicate image of the one or more images associated with the search result is excluded from determining the count of the one or more images relevant to the search result.

15. The computer program product of claim 9, further comprising:
combining, by the computer processor, the unstructured data associated with duplicate images of the one or more images of the search result, into an enhanced set of unstructured data associated with one of the duplicate images.

16. A computer system for determining a search result having one or more images that are relevant to text content of the search result, the computer system comprising:
one or more computer processors;
one or more computer readable storage media; and
program instructions stored on the computer readable storage media for execution by at least one of the one or more processors, the program instructions comprising:
program instructions to identify a search result of a plurality of search results that includes one or more images and unstructured data corresponding to metadata of the one or more images, and unstructured data corresponding to text content in proximity of the one or more images;
program instructions to perform a semantic analysis of the unstructured data of the search result;
program instructions to determine a relevance of the one or more images to the unstructured data of the search result, based, at least in part, on the semantic analysis of the unstructured data and the one or more images of the search result;
program instructions to determine a count of the one or more images determined to be relevant to the search result; and
program instructions to rank the search result of the plurality of search results, based on the count of the one or more images determined to be relevant to the search result.

17. The computer system of claim 16, wherein the search result which includes a greater count of images that are relevant to the unstructured data of the search result, is displayed in a priority ahead of another search result which includes a lesser count of images that are relevant to the search result.

18. The computer system of claim 16, further comprising:
program instructions to exclude a first image of the one or more images, from a determination of the count of the one or more images that are relevant to the search result, based on the determination of the first image to be an advertising image on a web page of the search result.

19. The computer system of claim 16, wherein a duplicate image of the one or more images associated with the search result is excluded from determining the count of the one or more images relevant to the search result.

20. The computer system of claim 16, further comprising:
program instructions to combine the unstructured data associated with duplicate images of the one or more images of the search result, into an enhanced set of unstructured data associated with one of the duplicate images.
